(19) United States
(12) Patent Application Publication
(10) Pub. No.: US 2020/0382234 A1
(43) Pub. Date: Dec. 3, 2020

(54) Reconfigurable Point to Mulitpoint Connections

(71) Applicant: Rushmere Technology Limited, Suffolk (GB)

(72) Inventors: Alistair POUSTIE, Suffolk (GB); James Ashley HARRISON, Suffolk (GB)

(21) Appl. No.: 16/961,411

(22) PCT Filed: Jan. 11, 2019
(86) PCT No.: PCT/GB2019/050081

§ 371 Date: Jul. 10, 2020

(30) Foreign Application Priority Data
Jan. 11, 2018 (GB) 1800492.9

(51) Int. Cl. H04J 14/02

(52) U.S. Cl. CPC H04J 14/0297; H04J 14/0263

(57) ABSTRACT

There is presented an apparatus for use with a Wavelength Division Multiplexed Passive Optical Network (WDM-PON). The apparatus comprises an electronic controller, optical transmitters and a wavelength multiplexer. The electronic controller is configured to receive first input electrical data signals, output electrical data signals on data channels based upon the input electrical data signals and change the data rate of at least a first of the output electrical data signals. The optical transmitters, which receive the electrical data signals, are each configured to receive, respectively on different data channels, electrical data signals output from the electronic controller. The optical transmitters output light signals corresponding to the received electrical data signals from the electronic controller. Respective light signals of each optical transmitter are centred on a different wavelength to the light signals of the other optical transmitters. The wavelength multiplexer is configured to receive the output light signals from the optical transmitters and output a wavelength multiplexed optical output signal.

### FIELD

The present invention is in the field of optical networks and apparatus for use with optical networks, in particular, but not limited to apparatus for use with a Wavelength Division Multiplexed Passive Optical Network (WDM-PON).

### BACKGROUND

With increasing demand for data capacities and bandwidth, optical technologies have been successfully developed to facilitate high-capacity, long distance transmission of optical data over optical fibre networks. These networks often use Dense Wavelength Division Multiplexing (DWDM) to allow one or more optical sources with different wavelengths to traverse a single optical fibre.

Recently, several optical Passive Optical Network (PON) architectures have been used to distribute data streams to many different customers. These include Gigabit-capable Passive Optical Networks (GPON) and Next-Generation Passive Optical Network 2 (NGPON2), where each user shares the aggregate bandwidth of the fibre link by using different wavelengths and temporal bursts for each user.

More recently, DWDM has also been considered for point-to-multipoint connections, to fully utilise the bandwidth for symmetric data services. This can be implemented as a Wavelength Division Multiplexing Passive Optical Network (WDM-PON). These networks are virtual point-to-point networks where a specific wavelength is routed to a specific network node. The wavelengths are routed to each node by a wavelength selective space multiplexer/demultiplexer, such as an Arrayed Waveguide Grating (AWG).

New applications are emerging, such as over-the-top content (OTT) service delivery where audio, video, and other media are transmitted via the Internet as a standalone product in access networks. These new applications can give rise to different downstream data requirements that vary in time and between node to node. Such varying data requirements may not be achievable using traditional Passive Optical Network (PON) architectures.

U.S. Pat. No. 6,404,522 describes an optical communication method and system using WDM.

EP1189477 describes a bit rate independent optical cross-connect device in optical transmission system.

### SUMMARY

In a first aspect of the present invention there is presented an apparatus for use with a Wavelength Division Multiplexed Passive Optical Network (WDM-PON). The apparatus comprises an electronic controller, optical transmitters and a wavelength multiplexer. The electronic controller is configured to receive first input electrical data signals, output electrical data signals on data channels based upon the input electrical data signals and change the data rate of at least a first of the output electrical data signals. The optical transmitters, which receive the electrical data signals, are each configured to receive, respectively on different data channels, electrical data signals output from the electronic controller. The optical transmitters output light signals corresponding to the received electrical data signals from the electronic controller. Respective light signals of each optical transmitter are centred on a different wavelength to the light signals of the other optical transmitters. The wavelength multiplexer is configured to receive the output light signals from the optical transmitters and output a wavelength multiplexed optical output signal.

In a second aspect of the present invention there is also presented an apparatus for use with a WDM-PON, where an electronic controller is configured to receive first input electrical data signals and output electrical data signals based upon the input electrical data signals. At least a first and a second of the plurality of electrical data signals are output at different rates on a plurality of data channels. The apparatus also comprises optical transmitters for receiving the electrical data signals. At least a first and second of the optical transmitters are configured to receive, on different data channels, the respective first and second electrical data signals output from the electronic controller, and output light signals corresponding to the received electrical data signals from the electronic controller. Respective light signals of each optical transmitter are centred on a different wavelength to the light signals of the other optical transmitters. The apparatus also comprises a wavelength multiplexer configured to receive the output light signals from the optical transmitters and output a wavelength multiplexed optical output signal.

The first and second aspects may be modified in any way described herein, including but not limited to any one or more of the following.

The apparatus may further comprise a wavelength demultiplexer and a plurality of optical receivers. The wavelength demultiplexer may be configured to receive wavelength multiplexed input light and output a plurality of light signals on different output paths, the output light signals centred on different wavelengths. The plurality of optical receivers may be for receiving the plurality of output light signals from the wavelength demultiplexer; and, outputting corresponding second electrical data signals to the electronic controller.

This apparatus may further comprise an optical unit configured to: direct the wavelength multiplexed optical output signal towards a further wavelength demultiplexer; the further wavelength demultiplexer configured to distribute light to a plurality of terminal devices; and, direct light received back from the further wavelength demultiplexer to the wavelength demultiplexer. Such an optical unit may be an optical circulator. It is understood that the further wavelength demultiplexer acts as a multiplexer when light is directed through it in the opposite direction to that when the same device is used in a demultiplexing capacity.

The electronic controller may be configured to change the data rate of at least the first electrical data signal or any of its plurality of output electrical data signals.

The electronic controller may be configured to change the said data rate based on any of:
A) An analysis of the input electrical data signals received by the electronic controller;
B) A data signal received by the electronic controller that is configured to cause the electronic controller to change a data rate.

The electronic controller may be configured to change the said data rate based on one or more of the electrical data signals output from one or more of the plurality of optical receivers.

The apparatus may further comprise a wavelength tuneable optical transmitter apparatus configured to: receive an electrical data signal associated with the said plurality of data signals; and, output corresponding light signals. A plurality of such wavelength tuneable optical transmitter apparatus may be incorporated into the apparatus.

The apparatus may further comprise an optical coupler configured to couple the light signals output from the wavelength tuneable optical transmitter into the wavelength multiplexed optical output signal.

This coupling may be between: the output port of the wavelength multiplexer and optical circulator; or between the circulator and a further multiplexer/demultiplexer.

The apparatus may be configured to receive a status signal comprising data associated with the light output from at least one of the optical transmitters of the plurality of optical transmitters and output the electrical signal to the wavelength tuneable optical transmitter apparatus based upon the status signal.

The status signal may indicate that the light signals output from the respective optical transmitter do not correspond to its respective received electrical data signals. This may be for example the output light pulses data having a greater number of errors, (greater bit error rate) than a threshold. This could also be, for example the transmitter not outputting light or outputting light at an intensity below a threshold. Any of these thresholds may be predetermined thresholds. In this manner, the apparatus may advantageously switch the data to the tuneable source when the nominal optical transmitter at that wavelength is not functioning properly.

The electrical signals transmitted to the wavelength tuneable optical transmitter apparatus may comprise any one or more of:
A) one or more signals for determining the centre output wavelength of the wavelength tuneable optical transmitter; and,
B) the electrical data signals output to the said at least one optical transmitter associated with the status signal.

The wavelength tuneable optical transmitter apparatus may comprise a wavelength tuneable laser. The tuneable laser may be directly modulated or have its output light externally modulated with an optical modulator.

The electronic controller may be further configured to: receive the first input electrical data signals from a transceiver; output electrical data signals, based on the second electrical data signals, to the said transceiver.

The electronic controller may be configured to transmit and receive data to and from the transceiver at data rates of 10 GHz or greater.

The apparatus described herein may further comprise the transceiver.

There is presented a system comprising the apparatus as described above and any one or more of: the further wavelength demultiplexer; and/or, the plurality of terminal devices.

In a third aspect of the present invention there is provided a method for operating an apparatus for use with a Wavelength Division Multiplexed Passive Optical Network, WDM-PON; the method comprising: using an electronic controller to: receive first input electrical data signals and output a plurality of electrical data signals based upon the input electrical data signals. The output electrical data signals may be output on a plurality of data channels. The method further comprises changing the data rate of at least a first of the plurality of output electrical data signals.

The method further comprises: using a plurality of optical transmitters to receive the plurality of electrical data signals; wherein each said optical transmitter is configured to: receive, respectfully on different data channel, electrical data signals output from the electronic controller; and, output light signals corresponding to the received electrical data signals from the electronic controller. Each said optical transmitter is configured to output its respective light signals centred on a different wavelength to the light signals of the other optical transmitters.

The method also comprises using a wavelength multiplexer to receive the output light signals from at least the first and second optical transmitters and output a wavelength multiplexed optical output signal.

In a fourth aspect of the present invention there is also presented a method for operating an apparatus for use with a Wavelength Division Multiplexed Passive Optical Network, WDM-PON; the method comprises: using an electronic controller to: receive first input electrical data signals and output a plurality of electrical data signals based upon the input electrical data signals; output at least a first and a second of the plurality of electrical data signals at different data rates.

The method further comprises: using a plurality of optical transmitters to receive the plurality of electrical data signals; wherein at least a first and second of the said optical transmitters are configured to: receive the respective first and second electrical data signals output from the electronic controller; and, output light signals corresponding to the received electrical data signals from the electronic controller. The light signals output from the first and second optical transmitters are centred on different wavelengths.

The method also comprises using a wavelength multiplexer to receive the output light signals from at least the first and second optical transmitters and output a wavelength multiplexed optical output signal.

According to a fifth aspect of the present invention there is presented an apparatus for use with a WDM-PON. The apparatus comprises an electronic controller configured to: receive first input electrical data signals and output a plurality of electrical data signals based upon the input electrical data signals. The output electrical data signals are output on a plurality of data channels.

The apparatus comprises a plurality of optical transmitters for receiving the plurality of electrical data signals. Each optical transmitter is configured to receive, respectively on different data channels, electrical data signals output from the electronic controller and output light signals corresponding to the received electrical data signals. Respective light signals of each optical transmitter are output centred on a different wavelength to the light signals of the other optical transmitters.

The apparatus additionally comprises a wavelength multiplexer configured to receive the output light signals from the optical transmitters and output a wavelength multiplexed optical output signal.

The apparatus also comprises a wavelength tuneable optical transmitter configured to receive one or more of the plurality of electrical signals output from the electronic controller and output light signals corresponding to the received electrical data signals from the electronic controller.

The fifth aspect may be modified in any way described herein including, but not limited to any one or more of the following and/or any one or more of the optional features described for the first and second aspects above.

The wavelength of the light signal output from the wavelength tuneable optical transmitter may be substantially the same as the wavelength of at least one of the said plurality of optical transmitters.

The additional aspect of the apparatus may be configured to initiate the output of light from the wavelength tuneable optical transmitter upon the detection of a fault associated with the operation of the apparatus.

The fault may be associated with one or more of the plurality of optical transmitters.

Upon detection of the fault, the apparatus may be configured to transmit one or more signals to the wavelength tuneable optical transmitter to, in any order:
A) output light;
B) tune its output wavelength to the wavelength of the faulty optical transmitter.

The electronic controller may be configured to output electrical data signals to the wavelength tuneable optical transmitter upon detection of the fault, the electrical data signals output to the wavelength tuneable optical transmitter based upon the said input electrical data signals.

The wavelength tuneable optical transmitter may comprise a wavelength tuneable optical source optically coupled to an optical modulator. The electronic controller is configured to output the said electrical data signals to the optical modulator.

The additional aspect of the apparatus may additionally comprise any one or more optical couplers configured to: receive wavelength multiplexed optical output signal from the wavelength multiplexer; receive light output from the wavelength tuneable optical transmitter; and output light, along a common optical path, from the wavelength tuneable optical transmitter and wavelength multiplexer.

The additional aspect of the apparatus may comprise an optical coupler configured to couple the light signals output from the wavelength tuneable optical transmitter into the wavelength multiplexed optical output signal.

According to a sixth aspect of the present invention there is provided an apparatus for use with a Wavelength Division Multiplexed Passive Optical Network, WDM-PON; the apparatus comprising: an electronic controller configured to: receive first input electrical data signals; and, output a plurality of electrical data signals based upon the input electrical data signals; the output electrical data signals being output on a plurality of data channels; a plurality of optical transmitters for receiving the plurality of electrical data signals; wherein each said optical transmitter is configured to: receive, respectively on different data channels, electrical data signals output from the electronic controller; and, output light signals corresponding to the received electrical data signals from the electronic controller; output its respective light signals centred on a different wavelength to the light signals of the other optical transmitters; a wavelength multiplexer configured to receive the output light signals from the optical transmitters and output a wavelength multiplexed optical output signal; a wavelength demultiplexer configured to receive wavelength multiplexed input light and output a plurality of light signals on different output paths; the output light signals being centred on different wavelengths; a plurality of optical receivers for: receiving the plurality of output light signals from the wavelength demultiplexer; and, outputting corresponding second electrical data signals to the electronic controller; a wavelength tuneable optical receiver configured to: receive wavelength multiplexed input light and, select a wavelength to detect from the said input light; output an electrical data signal to the electronic controller, based on the detected wavelength.

The sixth aspect may be modified in any way described herein including, but not limited to any one or more of the optional features described for any of the first and second aspects and fifth aspect above.

### BRIEF DESCRIPTION OF THE FIGURES

FIG. 1 shows a schematic diagram of an example of an apparatus as described herein which is configured to output downstream optical signals;

FIG. 2 shows a schematic diagram similar to the example of FIG. 1 and further comprising features to receive upstream optical signals;

FIG. 3 shows a schematic diagram similar to the example of FIG. 2 and further comprising further features of the network to receive the downstream optical signals and transmit the upstream optical signals;

FIG. 4 shows a schematic diagram similar to the example of FIG. 3 and further comprising a tuneable optical transmitter;

FIG. 5 shows a schematic diagram similar to the example of FIG. 3 and further comprising a wavelength tuneable optical receiver;

FIG. 6 shows an example of an apparatus used in a WDM passive optical network where AWGs are used to multiplex and demultiplex optical signals;

FIG. 7 shows an example of an apparatus similar to the example of FIG. 5 and further comprising a tuneable laser;

FIG. 8 shows an example of an apparatus similar to the example of FIG. 5 and further comprising a wavelength tuneable optical receiver.

### DETAILED DESCRIPTION

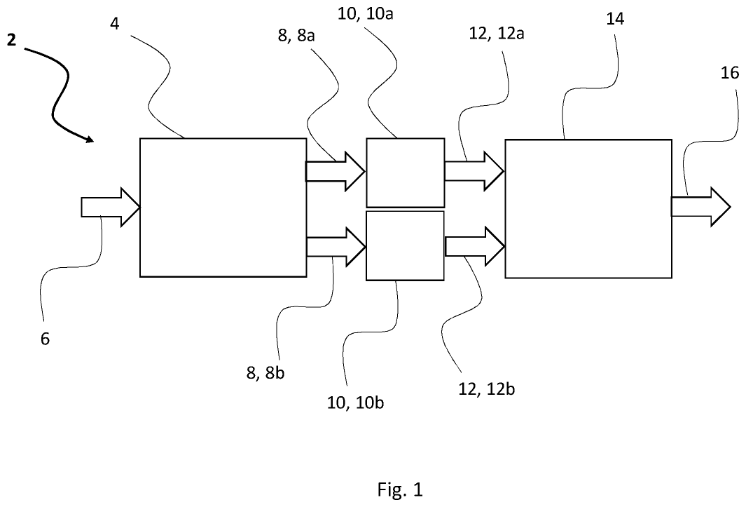

In a first aspect, there is presented an apparatus for use with a Wavelength Division Multiplexed Passive Optical Network (WDM-PON). A schematic diagram of an example of the apparatus is shown in FIG. 1.

The apparatus 2 in this aspect comprises an electronic controller 4 that is configured to receive first input electrical data signals 6. These first input electrical data signals 6 may be received from a high-speed optical transceiver (not shown in FIG. 1) that receives optical signals from other connecting networks and outputs corresponding electrical signals. These output electrical signals are the ‘first input electrical signals’ 6. The data contained within the optical signals from the connecting network corresponds to the data of the electrical data signals 6. The connecting optical network may be any network in principle, including, but not limited to a long haul, metro or other optical network. Such a connecting network may be termed an adjacent network and may operate at any feasible data rate, including, but not limited to any one of the following: above 10 Gbps, above 40 GBps, above 100 Gbps, 600 Gbps or above.

The electronic controller 4 is also configured to output a plurality of electrical data signals 8, 8a, 8b based upon the input electrical data signals 6 wherein the output electrical data signals 8, 8a, 8b are output on a plurality of data channels. The electronic controller 4 may also be configured to change the output data rate of at least a first 8a of the plurality of output electrical data signals 8, 8a, 8b. The data dates of each of the individual output electrical channels 8 are typically lower than that of the input data 6. This may be because the electronic controller 4 time-demultiplexes and divides the incoming data into different output channels 8. The electronic controller may alternatively or additionally break down the incoming data 6 into packets for distribution to the different end users.

The term ‘data rate’ is to be understood as the frequency at which respective data bits are transmitted to and/or received by components, in the apparatus 2 presented herein. Data rates may be within any suitable range. For example, the data rate may be any one or more of: 1 GB/s or greater, 5 GB/s or greater, between and including 1 GB/s and 40 GB/s, between and including 5 GB/s and 40 GB/s and between and including 10 GB/s and 40 GB/s.

The apparatus 2 also comprises a plurality of optical transmitters 10 for receiving the plurality of electrical data signals 8 output from the electronic controller 4. Each said optical transmitter 10 is configured to receive, respectively on different data channels, electrical data signals 8 output from the electronic controller 4. Each optical transmitter 10 is also configured to output light signals 12 corresponding to the received electrical data signals 8 from the electronic controller 4 wherein the light signals output from the optical transmitters 10 are centred on different wavelengths such that each optical transmitter 10 outputs light signals, for example, light pulses, at a different central wavelength to other optical transmitters 10.

The apparatus 2 also comprises a wavelength multiplexer 14 configured to receive the output light signals 12 from the optical transmitters 10 and output a wavelength multiplexed optical output signal 16. This wavelength multiplexed optical output signal 16 may be output along an optical path, for example along an optical fibre or optical waveguide.

The wavelength multiplexed optical output signal 16 may be output into a WDM-PON (not shown in FIG. 1) which then routes the signals to a further apparatus (as described below) to distribute the different wavelength channels to different terminal devices that correspond to different end users.

The ‘end user’ may refer to a customer, building or other terminal location that may receive the data stream, perhaps via a terminal apparatus or device at the end point of the WDM-PON.

In existing WDM-PON systems, electrical data may be routed to multiple transmitters at a fixed data rate. For example, electrical data may be transmitted to multiple end users at a fixed rate of 10 GB/s each.

The inventors of the present application have identified that there may be situations where the same end user requires different data rates at different times. For example, in the morning the user may require a low data rate, such as 10 GB/s but in the afternoon or on a different day, the end user may require a higher data rate, such as 40 GB/s. With the apparatus 2 described herein above, the data rate supplied to the user may be variable. The data rate may be reconfigured at any time, on any day/date and for any reason. For example, the change may occur periodically and/or be based on the pattern history of the end user's data usage. Additionally, or alternatively, it may depend on the comparison of the currently used data rate to a threshold value. For example, the data rate supplied may change when the data usage has dropped or risen to a certain value or where no data has been used.

If the electronic controller 4 has a fixed overall electrical bandwidth for electrical signals to be transmitted to the optical transmitters 10 then having the flexibility to change the data rates may allow the system to adapt to and balance network needs without necessarily compromising the bandwidth of a particular wavelength channel to a terminal device. This flexible system also allows network administrators to simply change the service quality to a user. For example, if an end user is unable or unwilling to pay, at a particular time, for a high data rate subscription then the network may be simply configured, at the electronic controller 4, to ensure that the end user only gets a service that they can afford. Reducing data rates as and when required also means that components that degrade with high intensity use, are prolonged in service life. Conversely, for an end user that requires more data, the electronic controller may increase the data rate sent to that user terminal.

In a further aspect, there is also provided an apparatus 2 for use with a WDM-PON. The apparatus 2 can similarly be represented by FIG. 1. The apparatus 2 comprises an electronic controller 4 and is configured to receive first input electrical data signals 6. The electronic controller in this further aspect is configured to output at least a first and a second of the plurality of electrical data signals 8a and 8b at different data rates, wherein the output electrical data signals 8a and 8b are output on a plurality of data channels. These different data rates on the different channels 8 may be fixed or may be variable, as discussed above or elsewhere herein.

The apparatus 2 also comprises a plurality of optical transmitters 10 for receiving the plurality of electrical data signals 8. At least a first 10a and second 10b of the optical transmitters 10 are configured to receive, on different data channels, the respective first 8a and second 8b electrical data signals 8, output from the electronic controller 4. At least a first 10a and second 10b of the said optical transmitters 10, are also configured to output light signals 12 (12a and 12b), corresponding to the received electrical data signals 8a and 8b from the electronic controller 4, wherein the light signals output from the first 10a and second 10b optical transmitters 10 are centred on different wavelengths. The apparatus 2 also comprises a wavelength multiplexer 14 configured to receive the output light signals 12 from at least the first 10a and second 10b optical transmitters 10 and output a wavelength multiplexed optical output signal 16.

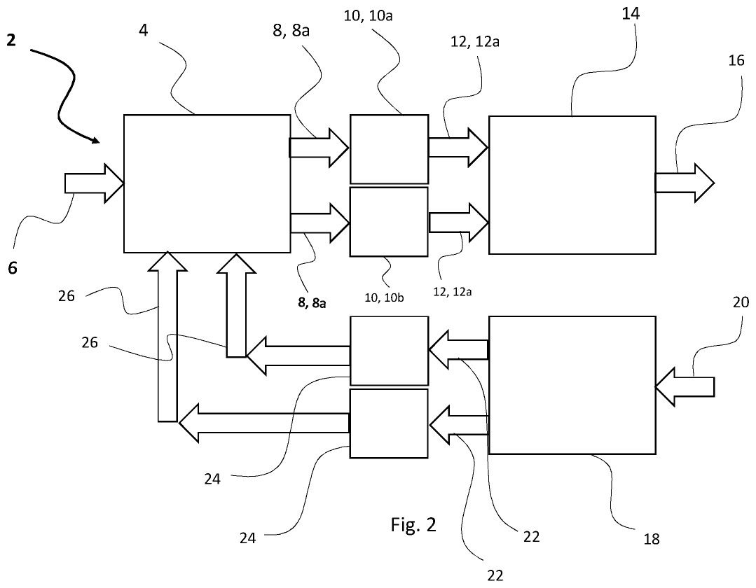

The examples in FIGS. 1-5 only show two electrical data signals 8a and 8b, two optical transmitters 10a and 10b and two output light signals 12a and 12b, however it is understood that two or more of the: electrical data signals 8; optical transmitters 10, and corresponding light signal channels 12 may be used. Similarly, with respect to FIGS. 2-5, more than two of the: light signals 22; optical receivers 24; and electrical data signals 26 may also be utilised by versions of the apparatus 2.

The apparatus 2 according to this further aspect therefore allows for electrical data signals at different data rates to be output onto a WDM-PON so that end users that have different data requirements can be serviced accordingly. For example, some end users may consistently require a higher data rate than others. With the apparatus 2 described herein, the data rate may be different for different end users. By outputting electrical data signals at different data rates to different end users, according to factors such as how much data they typically use or how much data they would like to use, end users are able to receive and pay for data rates representative of their requirements. The apparatus presented herein can hence improve cost efficiency.

This may usefully allow network administrators to assign different data rate tariffs to different customers. For example, one tariff might provide a certain data rate for a certain price and another tariff might provide a different data rate for a different price. Furthermore, some end users may consistently use or request a high data rate, such as (but not limited to) 50 GB/s. For example, a large company may require lots of people in the same building (e.g. more than 100 people) to use the Internet at the same time or their work may heavily involve network communications. Other end users may consistently use or request a lower data rate. For example, a small company or domestic household may prefer a lower data rate, perhaps if their work/daily activities involve minimal internet usage.

By providing end users with different data rates, end users can be set up with the equipment necessary to meet their data rate requirements or requests. For example, this may include any one or more components of the apparatus 2 described herein configured to operate with particularly high data rates.

Since end users can be provided with the data rate they require, resources are not wasted obtaining unnecessarily high data rates. Not only does the apparatus 2 therefore improve cost efficiency, it also improves energy efficiency. The following discussions including any optical configurations and features may be applicable to any of the aspects and examples of the apparatus 2 as described herein.

Examples of the apparatus 2 are shown in FIGS. 1-5. FIG. 1 shows an example of the apparatus 2 where the electrical data 8 and light signals 12 are propagating downstream, from the electronic controller 4 to the terminal devices 32.

The wavelengths of light used by the apparatus 2 may be any suitable wavelengths, for example wavelength ranges for communication systems, such as infrared. For example, the wavelength may be any wavelength value between the O band and the U band, ranging from 1260-1675 nm. The range of compatible wavelengths may, for example, be any one or more of: 1260-1360 nm (original, O band), 1360-1460 nm (extended, E band), 1460-1530 nm (short wavelengths, S band), 1530-1565 nm (conventional, C band), 1565-1625 nm (long wavelengths, L band) and 1625-1675 nm (ultra-long wavelengths, U band).

Light may propagate from different components within and/or to or from external components of the apparatus 2 using any suitable means. This may for example include any one or more of: free space propagation using bulk optic components to direct the light, using optical fibres and/or integrated optic waveguides to guide the light. Examples include buried channel waveguides, laser-inscribed waveguides and/or strip waveguides. Alternatively, or additionally, the light may be directly transmitted from adjoining components and/or via a direct laser beam.

### Electronic Controller

The electronic controller 4 may be configured to receive input electrical data signals 6 and change the data rate of at least a first of the plurality of output electrical data signals 8 and/or receive input electrical data signals 6 and output at least a first and second of the plurality of electrical data signals 8 at different data rates, on different respective channels. Changing the data rate of at least a first of the plurality of output electrical data signals 8 may comprise any of: A) re-setting the output data rate for a channel from an existing data rate to a different data rate; B) changing the data rate dynamically during a period where data is being output along the channel, for example changing the data rate in between successive packets of data.

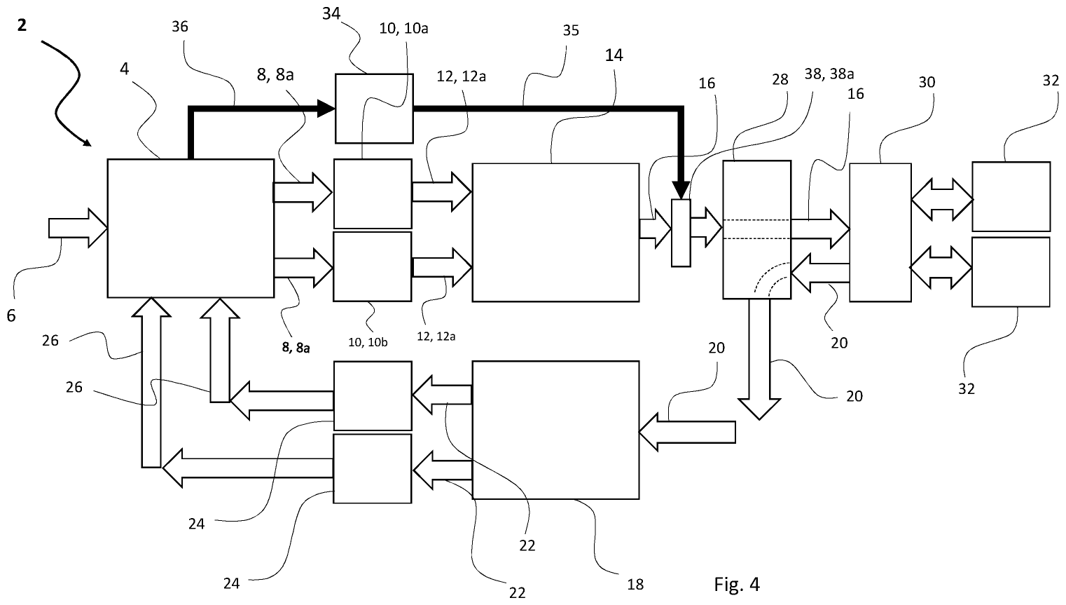

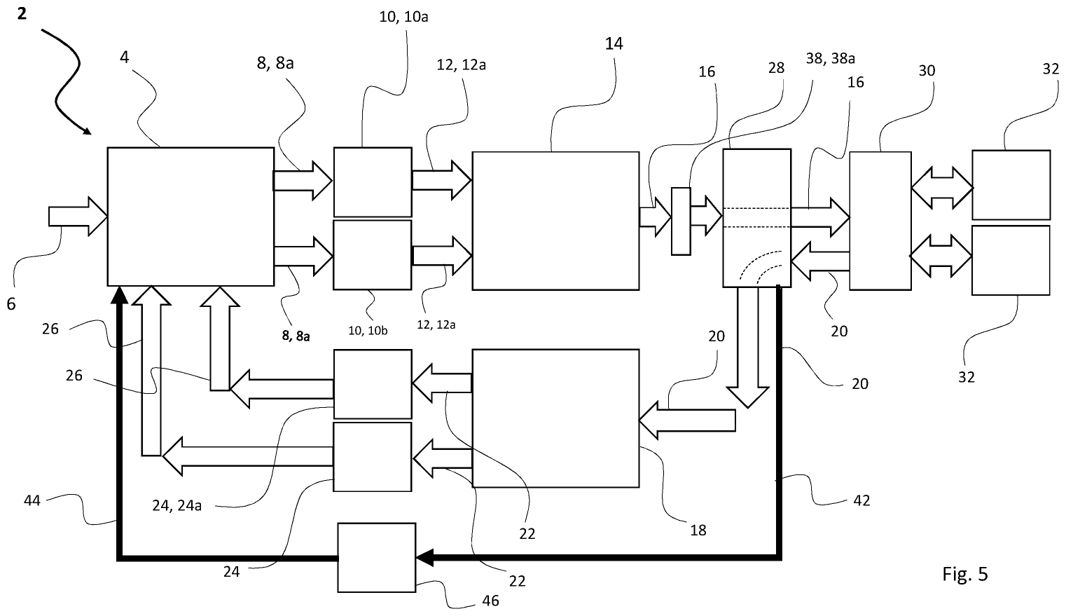

In some examples the controller 4 receives electrical signals 26 (see below, and FIGS. 4 and 5) that contain upstream data from the end user, intended for transmission to a further network, for example via the bi directional electrical communication channel that is used to deliver the first input electrical data signals 6 to the electronic controller 4. In some examples the controller 4 may receive electrical signals 26 and a further electrical signal 44, as discussed below. The controller 4 is configured to transmit further electrical signals to other devices, for example devices in a core network. The subsequently transmitted signals to another network such as a core network, may be based on the received electrical signals 26 wherein at least one of the received electrical signals 26 is replaced by the electrical signal 44. The received electrical signals 26 may be signals from a plurality of optical receivers 24 wherein each optical receiver 24 has an output electrical signal channel that is physically separate to the output electrical signal channels of the other optical receivers 24. If the apparatus is configured to receive further electrical signals 44 along a further electrical signal channel then the electronic controller may transmit, to the adjacent network, the data contained in the further electrical signals 44 in place of data received from one or more of the electrical signals 26 received from the corresponding optical receiver 24.

A ‘channel’ is intended to mean a propagation path that the signal takes to get to its destination. A channel that is used to transport electrical signals may have any appropriate wires or cables or other electrical signal carrying structure. A channel that is used to transport optical signals may have any appropriate structure such as, but not limited to integrated waveguides, free space light propagation or optical fibre. The electrical signals described herein are transmitted and received using appropriate electronic transmitter and receiver components. The optical signals described herein are transmitted and received using appropriate optical transmitter and receiver components.

The electronic controller 4 may electrically direct the channels of electrical data signals 8, e.g. 8a, 8b) to different output ports, which in turn feed the optical transmitters 10, e.g. 10a, 10b.

The electrical controller 4 may take the form of a computer, use one or more printed circuit boards (PCB's), or comprise a processor and optionally memory elements having any software that performs this function. There may be a singular electronic controller or a plurality of electronic controllers.

The electronic controller may have an electronic processing means that is configured to control the operation of the controller and determine the data rates sent to the optical transmitters 10.

Examples of electronic processing means are described as follows.

The processing means may comprise one or more processing devices. Any of the processing devices described herein may comprise one or more electronic devices. An electronic device can be, e.g., a computer, e.g., desktop computer, laptop computer, notebook computer, minicomputer, mainframe, multiprocessor system, network computer, e-reader, netbook computer, or tablet. The electronic device can be a smartphone or other mobile electronic device.

The computer can comprise an operating system. The operating system can be a real-time, multi-user, single-user, multi-tasking, single tasking, distributed, or embedded. The operating system (OS) can be any of, but not limited to, Android®, iOS®, Linux®, a Mac operating system and a version of Microsoft Windows®. Any apparatus, systems and methods described herein can be implemented in or upon computer systems. Equally, the processing device may be part of a computer system.

Computer systems can include various combinations of a central processor or other processing device, an internal communication bus, various types of memory or storage media (RAM, ROM, EEPROM, cache memory, disk drives, etc.) for code and data storage, and one or more network interface cards or ports for communication purposes. The apparatus, systems, and methods described herein may include or be implemented in software code, which may run on such computer systems or other systems. For example, the software code can be executable by a computer system, for example, that functions as the storage server or proxy server, and/or that functions as a users terminal device. During operation the code can be stored within the computer system. At other times, the code can be stored at other locations and/or transmitted for loading into the appropriate computer system. Execution of the code by a processor of the computer system can enable the computer system to implement the methods and systems described herein.

The computer system, electronic device, or server can also include a central processing unit (CPU), in the form of one or more processors, for executing program instructions. The computer system, electronic device, or server can include an internal communication bus, program storage and data storage for various data files to be processed and/or communicated. The computer system, electronic device, or server can include various hardware elements, operating systems and programming languages. The electronic device, server or computing functions can be implemented in various distributed fashions, such as on a number of similar or other platforms.

The methods and steps performed by components described herein can be implemented in computer software that can be stored in the computer systems or electronic devices including a plurality of computer systems and servers. These can be coupled over computer networks including the internet. This network may be the same or a different network to the PON that the electronic controller 4 serves. The methods and steps performed by components described herein can be implemented in resources including computer software such as computer executable code embodied in a computer readable medium, or in electrical circuitry, or in combinations of computer software and electronic circuitry. The computer-readable medium can be non-transitory. Non-transitory computer-readable media can comprise all computer-readable media, with the sole exception being a transitory, propagating signal. Computer readable media can be configured to include data or computer executable instructions for manipulating data. The computer executable instructions can include data structures, objects, programs, routines, or other program modules that can be accessed by a processing system Computer-readable media may include, but are not limited to, non-volatile storage media in various forms (e.g., optical, magnetic or semiconductor storage media, hard disk, optical disk, magneto-optical disk), volatile media (e.g., dynamic memories) and carrier waves that can be used to transfer such formatted data and/or instructions through wireless, optical, or wired signalling media, transmission media (e.g., coaxial cables, copper wire, fibres optics) or any combination thereof.

The terms processing, computing, calculating, determining, or the like, can refer in whole or in part to the action and/or processes of a processor, computer or computing system, or similar electronic computing device, that manipulate and/or transform data represented as physical, such as electronic, quantities within the system's registers and/or memories into other data similarly represented as physical quantities within the system's memories, registers or other such information storage, transmission or display devices. Users can be individuals as well as corporations and other legal entities. Furthermore, the processes presented herein are not inherently related to any particular computer, processing device, article or other apparatus. An example of a structure for a variety of these systems will appear from the description herein. Embodiments are not described with reference to any particular processor, programming language, machine code, etc. A variety of programming languages, machine codes, etc. can be used to implement the teachings as described herein.

An electronic device can be in communication with one or more servers. The one or more servers can be an application server, database server, a catalog server, a communication server, an access server, a link server, a data server, a staging server, a database server, a member server, a fax server, a game server, a pedestal server, a micro server, a name server, a remote access server (RAS), a live access server (LAS), a network access server (NAS), a home server, a proxy server, a media server, a nym server, network server, a sound server, file server, mail server, print server, a standalone server, or a web server. A server can be a computer.

One or more databases can be used to store information from an electronic device. The databases can be organized using data structures (e.g., trees, fields, arrays, tables, records, lists) included in one or more memories or storage devices.

The data that the electronic controller 4 uses to determine what data rate and what data goes to each optical transmitter 10 may be received from any one or more of, but not limited to any one or more of:
A) One or more data signals received from the first input data signals 6 (see FIG. 1). This may be data contained within a burst of data, data within a packet header, or data otherwise derived from the incoming data signals 6, such as determining the data rate from an incoming data rate.
B) One or more data signals from the upstream data sent from the terminal device 32. This may be data indicating a desired data rate; data indicating actual data usage which can be used to determine an appropriate data rate.
C) One or more data signals received from another external source, such as an electrical signal sent to the electronic controller 4 from a local network management system.
D) One or more data signals stored locally on an electronic data storage medium (such as the memory described above). This may be, for example, data stored within the memory that determines the data rate for a time of day. The data in the memory may be used with other data to determine the data rates of electrical signals sent to the optical transmitters 10. For example, the memory may store a plurality of rules or parameters to which other incoming data is compared with in order to determine the data rate of the output data 8. The memory may have a rule that only allows for a particular data channel to increase when the certain conditions occur, such as when the downstream data rate is lower that the received upstream data rate.

The electronic controller 4 can take the form of an Application Specific Integrated Circuit (ASIC) or Field Programmable Gate Array (FPGA), where specific switching, data rate selection, security, protocol conversion, quality of service and bit-rate coding functionality can be implemented in the controller. This allows different protocol data to be run on each wavelength channel if required and also traffic engineering to be applied to each data channel. The ASIC or FPGA can be configured so that software can be used to change the configuration state of the electronic controller. Electronic crossbar switching may route any of the lower data rate electrical signals to the output data ports 8. Electronic master clock selection and multiplication factor may control the data rate at the output data ports 8. Line coding, for example 64/66B for 10 Gigabit Ethernet, can also be applied to any or all of the output data ports 8. Forward error correction (FEC) can be applied to any or all of the output data ports 8.

### Electrical Data Signals

A plurality of electrical data signals 8, are output from the electronic controller 4 on a plurality of data channels 8a, 8b. The electrical data signals 8 may have different or identical data rates.

The data channels carrying the electrical data signals 8 output by the electronic controller 4 may be on separate physical paths or, at some point along their physical path be physically separated, so that each channel feeds into a separate optical transmitter 10. The optical transmitters 10 may be incorporated into the same device or be devices co-located into the same collection of apparatus. They may be separate to or be incorporated into the electronic controller.

The electronic controller 4 and the optical transmitters 10 may form at least part of a system that may be co-located into a common housing such as a rack or together form a composite device.

### Optical Transmitter

Each optical transmitter 10 is configured to receive, respectively on different data channels, electrical data signals from the electronic controller 4 and output light signals 12 corresponding to the received electrical data signals 8. The light signals 12 from the optical transmitters 10 are centred on different wavelengths.

The optical transmitter may output light signals by being directly modulated or may have its optical output, either continuous wave or pulsed, externally modulated by an optical modulator such as an electro-optical modulator or electro-absorption modulator. Examples of such modulators include, but are not limited to, semiconductor modulators, lithium niobate modulators or modulators fabricated using electro-optic polymers.

The optical transmitters 10 may take the form of any transmitter or transceiver. For example, the optical transmitters 10 may, for example, comprise any laser or other optical source. The optical transmitter 10 may be a single device or a collection of separate devices combined to form one optical transmitter apparatus. An example of a laser for use as an optical transmitter 10 is a distributed feedback laser (DFB).

The electronic controller 4 and the optical transmitters 10 may form at least part of a system that may be co-located into a common housing such as a rack or together form a composite device.

### Wavelength Multiplexer

The light signals 12 outputted from the optical transmitters 10 are received by one or more wavelength multiplexers 14. In FIGS. 1-5 a single multiplexer 14 is shown, however it is understood that multiple multiplexers 14 may be utilised, for example in a tree-like configuration. The wavelength multiplexer 14 may, for example, take the form of an integrated optics or bulk optics device. An example of a possible integrated optics wavelength multiplexer is an Arrayed Waveguide Grating (AWG), which is used to multiplex input optical signals of different channels into a wavelength multiplexed optical output signal 16. This output signal 16 may be transmitted downstream towards the terminal devices 32 and/or any other network elements such as a demultiplexing element (for example see below) that physically separates the wavelength channels and directs each channel to the terminal devices 32.

The wavelength multiplexers may include any suitable number of optical channels and may be any one or more of, but not limited to, Course Wavelength Division Multiplexers and Dense Wavelength Division Multiplexers.

The wavelength division multiplexers used may be rack-mountable and have indicators for monitoring features such as power or synchronisation. They may also have the ability to add or drop channels during operation.

The electronic controller 4, optical transmitters 10 and the multiplexer 14 may form at least part of a system that may be co-located into a common housing such as a rack or together form a composite device.

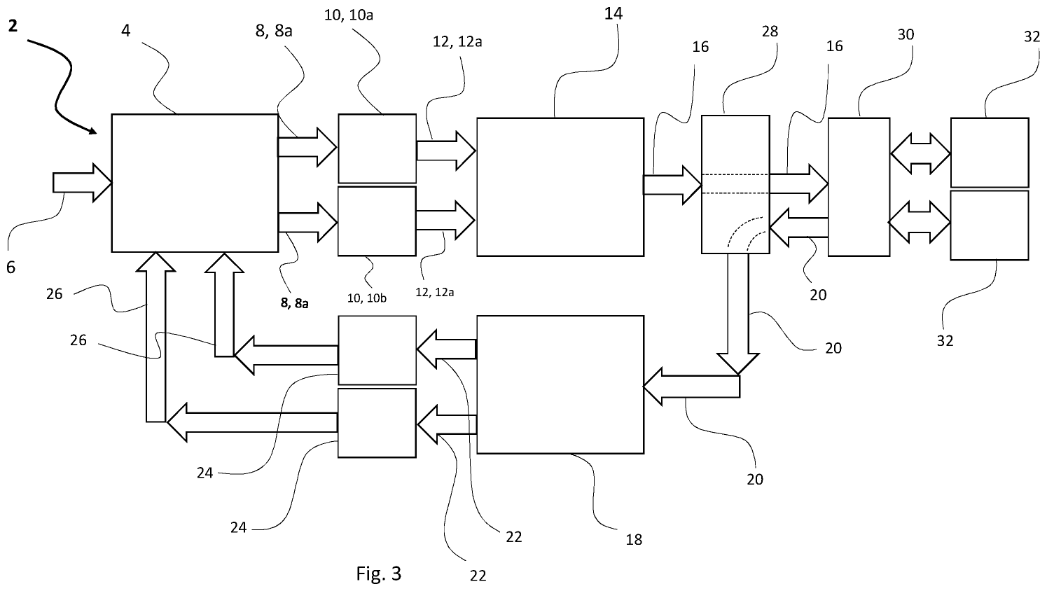

FIG. 2 shows the apparatus of FIG. 1 where like reference numerals represent like features, apart from where indicated herein. In addition to the component configuration allowing a downstream flow of data introduced in FIG. 1, FIG. 2 presents an example of how the apparatus 2 may be configured to allow the electronic controller 4 to receive upstream data flow, whereby data is transmitted from a terminal device 32 towards the electronic controller 4. For example, if an end user sends an email, the data comprising the content of the email may be sent from a terminal device 32 (see FIG. 3) to the electronic controller 4, which may then be directed to the email recipient via the apparatus 2 using, for example, a further device or connecting network.

### Demultiplexer

The apparatus 2 presented herein may also include one or more demultiplexers 18 and a plurality of optical receivers 24, as shown in FIG. 2.

Optical data signals may be transmitted upstream from the terminal devices 32 of the WDM-PON towards the electronic controller 4. These optical data signals are referred to herein as wavelength multiplexed input light 20 because at some point between the end users 32 and the demultiplexer 18, the optical signals output by each end user 32 are multiplexed together for transmission over a single physical channel. The wavelength multiplexed input light 20 may be transmitted from a terminal device to one or more wavelength demultiplexers 18. The wavelength demultiplexers 18 receive the multiplexed input light 20 on a single channel and output a plurality of light signals 22 on different output channels, respective of their wavelength.

The wavelength demultiplexer(s) 18 may take any suitable form including but not limited to, diffraction gratings, optical filters and/or directional couplers. The wavelength demultiplexer 18 may be an AWG.

The wavelength multiplexer 14 and the wavelength demultiplexer 18 may or may not constitute the same type of multiplexer. In the present disclosure, an optical wavelength multiplexer or demultiplexer may also be referred to herein as a ‘mux’ or ‘demux’ respectively.

### Optical Receivers

The apparatus 2 described herein may also comprise a plurality of optical receivers 24 for receiving the plurality of output light signals 22 from the wavelength demultiplexer 18. The optical receivers 24 convert the light signals 22 into a second set of electrical signals 26. Any of the optical receivers may comprise one or more photodetectors that convert light signals into electrical signals. The receiver 24 may form part of a transceiver.

The optical demux 18 divides the incoming light 20 into separate wavelength channels 22, wherein the light signals 22 having same wavelength are transmitted to the same optical receiver 24.

The second set of electrical data signals 26 may be received by the electronic controller 4. These signals 26 may enable the apparatus 2 to change the data rate of the electrical signals 8 sent to the transmitters 10 and/or be transmitted to a further device or connecting network via the electronic controller 4. This may be done in any number of ways including, but not limited to any one or more of: 1) analysing the returning data rate and using one or more parameters or rules to determine whether the current data rate being sent downstream from the electronic controller 4 to that user is appropriate; 2) using a portion of the upstream data to determine whether the current data rate being sent downstream from the electronic controller 4 to that user is appropriate, wherein the said portion of data comprises information indicative of the users data usage and requirements.

The electronic controller 4, optical transmitters 10, multiplexer 14 and demultiplexer 18 and/or optical receivers 24 may form at least part of a system that may be co-located into a common housing such as a rack or together form a composite device.

### Optical Unit

FIG. 3 shows the apparatus of FIG. 2 where like reference numerals represent like features, apart from where indicated herein. The wavelength multiplexed optical output signal 16 may be transmitted downstream from the wavelength multiplexer 14 to an optical unit 28. This optical unit 28 may be configured to route optical signals travelling in different directions to different input and output ports such that returning upstream signals do not go back to the downstream optical source they came from. The optical unit may comprise, but is not limited to, an optical circulator and/or waveband splitter. In the example configuration of the apparatus described herein, the optical unit may direct the downstream optical output signal 16 at least towards a further wavelength demultiplexer 30.

### Further Wavelength Multiplexer and Terminal Devices

The wavelength multiplexed optical output signal 16 may be transmitted to a further wavelength demultiplexer 30 such as a downstream AWG. It is understood that the further wavelength demultiplexer 30 acts as a multiplexer when light is directed through it in the opposite direction to that when the same device is used in a demultiplexing capacity. The further wavelength demultiplexer 30 is configured to receive the wavelength multiplexed optical output signal 16 and demultiplex it into spatially separate optical outputs that are, distributed to a plurality of terminal devices 32.

Similarly to other mux/demux components described herein, the further wavelength demultiplexer 30 may be formed of a plurality of wavelength demultiplexers or other components that receive a wavelength multiplexed output on a single physical channel and output a plurality of spatially separated wavelength channels.

### Terminal Devices

Each terminal device 32 may comprise, but is not limited to, one or more node transceivers, or a device having separate optical transmitters and receivers. The terminal device may be a singular device or any combination of devices forming a system. The terminal devices 30 are configured to receive the light signals at a certain wavelength and data rate (which may be varied).

Each terminal device 32 may, for example, be situated at the site of the end user and allow the customer to receive and utilise the data and/or bandwidth.

To provide context, in one possible configuration, the electronic controller 4, optical transmitters 10 and first multiplexer 14 may be situated in a common location. They may, for example, be co-located on a mounting platform, housed in a rack in a communications centre. An optical fibre carrying the wavelength multiplexed signals may carry the light to a certain geographical area, where there is a local communications centre. The local communications centre may house the demultiplexer 30 which in turn separates the wavelengths into separate channels, each carried by a single mode or multimode optical fibre to terminal devices 32 serving different end users. The end users may, for example, refer to a particular building which houses a terminal device.

The terminal devices 32 may also transmit light signals upstream to the further wavelength demultiplexer 30, which multiplexes the light signals from a plurality of end users terminals 32, and transmits the light signals to the optical unit 28.

The optical unit 28 in this example is an optical circulator configured to direct light signals upstream from the further wavelength demultiplexer 30 to the wavelength demultiplexer 18. The light signals may then continue their path from the demultiplexer 18 to the electronic controller as shown in FIG. 2 and discussed previously.

For example, for an end user to receive an email, the electrical data signals comprising the contents of the email may be inputted downstream to the electronic controller 4. These electrical data signals are received by one or more optical transmitters 10, which convert it into optical signals. The optical signal is transmitted to an optical multiplexer 14, such as an AWG which enables other optical signals, perhaps comprising the contents of other emails to other end users, to be combined into one optical channel. This multiplexed optical signal may then be transmitted to an optical circulator 28 via a single optical fibre. The optical circulator may direct the multiplexed optical signal towards a wavelength demultiplexer, such as a downstream AWG 30 which separates the multiplexed optical signals according to their wavelength. The specific signal corresponding to the email is transmitted to the terminal device 32 serving the user's building, allowing the end user to receive the email.

In a similar example, if an end user sends an email, the optical signal may be transmitted from the terminal device 32 serving the end user's building to a wavelength demultiplexer such as the AWG 30 in a local communications centre.

Since the signal is now travelling in the opposite direction compared to the downstream data flow, the wavelength demultiplexer may now act as a wavelength multiplexer. Separate optical signals coming from different terminal devices may be multiplexed, combining the optical signals into a single optic fibre, which may then be transmitted to the optical circulator. The optical circulator 28 may then direct the optical signal 20 to a further AWG 18, which demultiplexes the signals 22 and distributes them to separate optical receivers 24, according to their wavelength. The optical receivers 24 may convert the optical signals into electrical signals 26 and transmit the electrical signals to the electronic controller 4. The electrical signal corresponding to the email may then be transmitted from the electronic controller to another device to be delivered to its recipient.

In any of the examples described herein, the wavelength multiplexer 30 used to combine the upstream optical signals from the plurality of end users 32 may be the same or a different device to the demultiplexer used to transmit the downstream optical signals to the user terminals 32. For the upstream signals, the end users 32 may use any one or more of:
1) a different wavelength (to the downstream signals)
2) different physical channels (to the downstream signals)
   to transmit the upstream optical signals.

For example, where different optical fibres are used to send downstream and upstream light signals to/from a user terminal, separate mux/demux devices may be used for the component 30 in FIG. 3. In this scenario, an optical circulator 28 is not required as the optical output of the upstream mux may be directly sent to the demux 18. Furthermore an optical coupler may be required in this example to couple light to the optical circulator.

In another example, the end user terminals 32 utilise different wavelengths on upstream transmission but utilise the same mux/demux 30. This may be done because the demux may be capable of operation in different bands of the wavelength spectrum.

### Reconfigurability

The electronic controller 4 may be configured to change the data rate of at least the first electrical data signal of its plurality of output electrical data signals 8 or output at least a first and second of the plurality of electrical data signals, 8a and 8b at different data rates. The data rate may be reconfigurable.

The electronic controller 4 may be configured to change the said data rate using any method or technical components. For example, this may involve an analysis of the input electrical data signals 6 or second electrical data signals 26 received by the electronic controller 4, to determine the desired data rate. Any component of the apparatus 2 described herein, such as the electronic controller 4, may then be configured to change the data rate accordingly. For example, this may be achieved by changing the clock multiplication factor or selecting a different frequency clock to the electronic controller. The frequency clock may control the pace at which a signal alternates between zero and one. By multiplying by a clock multiplication factor, the pace may increase or decrease.

As an example, the second electrical data signals transmitted by the optical receivers 26 and received by the electronic controller 4 may, for example, contain information on the data rate required or requested by the user 32. The second electrical data signals 26 may, for example, relate to how much data is being used by each user 32, whether the data being used is more than or less than a threshold or whether no data is being used. The analysis of this information by the electronic controller 4 may determine whether an increase or reduction of the data rate supplied should be instigated or whether the data rate should stay the same. The data usage may be measured using one or more optical taps and/or a throughput measuring software or hardware. For example, a portion of the optical output 12 from one or more of the optical transmitters 10 may be coupled into a detector apparatus (not shown) to determine a current data rate. If this information is fed back to the electronic controller 4 and/or transceiver 101, this may trigger the data rate sent to that particular transmitter 10, to be reconfigured for that data channel and corresponding end user. A request for a higher or lower data rate may also be manually requested by a user.

Alternatively, the reconfigurability may be controlled by another device or plurality of devices. For example, a network administrator may control what data rate is being supplied to each terminal device. Instructions on the data rate to supply to a certain user or multiple users may be sent, in the form of an electrical signal, to the electronic controller 4. The electronic controller 4 may then ensure that each terminal device receives the assigned data rate, for example by adjusting the clock multiplier or clock source accordingly, whereby a clock source is a reference signal so that multiple elements may be synchronised to the same time.

### Wavelength Tuneable Optical Transmitter and Wavelength Tuneable Optical Receiver

The apparatus may further comprise one or more wavelength tuneable optical transmitters 34, as shown in FIG. 4. FIG. 4 is similar to FIG. 3 with like references corresponding to like components. Additionally or alternatively, the apparatus 2 may further comprise one or more wavelength tuneable optical receivers 46, as shown in FIG. 5. Any of the examples described herein may utilise one or more wavelength tuneable optical transmitters 34 and/or wavelength tuneable optical receivers 46 as described below.

The wavelength tuneable optical transmitter 34 may be configured to receive electrical data signals 36 associated with at least one of the said plurality of output electrical data signals 8; and output corresponding light signals 35. The one or more wavelength tuneable transmitters 34 may be, for example one or more tuneable lasers. References made to a tuneable laser in the following examples equally refer to examples where other wavelength tuneable optical sources may be used.

The tuneable laser may be used in circumstances where a fault is detected in the transmission system between the electronic controller 4 and up to and including the output of the mux 14. Faults may occur for a variety of reasons, including any one or more of, but not limited to:
1) Faults in the electrical transmission path between the electronic controller 4 and an optical transmitter 10.
2) Faults with an optical transmitter 10.
3) Faults with the optical transmission path between an optical transmitter 10 and the mux 14 (for example a break in the optical fibre).
4) Faults with the mux 14 (for example, where the mux 14 is an integrated optic AWG; a break into the waveguide for a particular wavelength channel of the AWG).

The wavelength tuneable optical receiver 46 may be configured to receive electrical data signals associated with at least one of the said plurality of output light signals 22; and, output corresponding second electrical data signals 44. The one or more wavelength tuneable receivers may comprise, for example, a photo detector optically coupled to a tuneable wavelength filter which can be electronically controlled to change the transmission wavelength to one of the wavelengths of light 22 output by the demux 18.

The wavelength tuneable optical receiver 46 may be used in circumstances where a fault is detected in the transmission system between the input of the wavelength demultiplexer 18 and up to and including the electronic controller 4. Faults may occur for a variety of reasons, including any one or more of, but not limited to:
1) Faults in the electrical transmission path between an optical receiver 24 and the electronic controller 4.
2) Faults with an optical receiver 24.
3) Faults with the optical transmission path 22 between the wavelength demultiplexer 18 and an optical receiver 24 (for example a break in the optical fibre).
4) Faults with the wavelength demultiplexer 18 (for example, where the wavelength demultiplexer 18 is an integrated optic AWG; a break into the waveguide for a particular wavelength channel of the AWG).

The tuneable laser may therefore be used as a backup transmitter and/or the tuneable optical receiver may be used as a backup receiver if a component or waveguide corresponding to any channel does not sufficiently allow optical or electrical signals to reach other apparatus components (such as an AWG). The use of the tuneable transmitter 34 and/or tuneable optical receiver may be initiated by any number of reasons or criteria, including but not limited to: the intensity of the light signals 12, 22 is too low and/or the electrical data 8, 26 has not been correctly converted to light pulses by the optical transmitters 10 and/or optical receivers 24. For example, if one of the optical transmitters 10 has broken, which was meant to receive electrical signals on a certain data channel, and transmit light signals at a certain wavelength, the electrical signals on that data channel and with that wavelength can be diverted to a wavelength tuneable optical transmitter 34 instead. In another example, if one of the optical receivers 24 has broken, which was meant to receive light signals at a certain wavelength and transmit electrical signals on a certain data channel, the light signals at that wavelength may be diverted to a wavelength tuneable optical receiver instead and transmit electrical signals on that data channel. The tuneable transmitter 34 and/or tuneable receiver can be tuned to the appropriate wavelength to accommodate the data signals. The optical signal 42 that is input to the tuneable optical receiver 46 may be sourced from an optical tap from the optical signal 20 or a separate tap from the optical unit 28. The tap may be broadband or be wavelength selective. For the wavelength selective configuration, this may be affected by a device that, upon receiving a control signal, selects the appropriate wavelength to send to the receiver 46. In this configuration the receiver 46 may not require wavelength selectivity). A broadband optical tap may be selectively variable as well, for example, if none of the optical receivers 24 are faulty then the tap of light from the optical path 20 may be substantially zero, however when it is determined that there is a lack of reception of an appropriate electrical signal 24 at the electronic controller 4, (say for example path 24a), then a control signal may be output to:
I) a variable intensity optical coupler to couple a portion of the light 20 into optical path 42 path; and a tuneable wavelength filter of the tuneable optical receiver to tune the filter wavelength to the corresponding wavelength for signal 24a.
II) a tuneable wavelength filter of the tuneable optical receiver 46 to tune the filter wavelength to the corresponding wavelength for signal 24a. In this example, a broadband optical tap may be used to permanently tap a portion of light to receiver 46, wherein the default setting of the tuneable receiver is to not accept light or to tune its filter to a wavelength outside of the spectrum of the light in optical path 20.

The determination that use of the tuneable laser is to be initiated may be through any one or more of, but not limited to:
1) Coupling a portion of the electrical signal 8 to an electrical analyser to determine the electrical signal quality (for example excess electrical noise, poor signal to noise ratio, etc.). This may be referred to as an electrical tap.
2) Coupling a portion of output light from an optical transmitter 10 to an optical detector to determine optical signal quality. This may be referred to as an optical tap.
3) Coupling a portion of output light from the mux 14 to an optical detector to determine optical signal quality. This may be referred to as an optical tap.

The determination that use of the tuneable receiver is to be initiated may be through any one or more of, but not limited to:
1) Coupling a portion of the input light from an optical receiver 24 to an optical detector to determine optical signal quality. This may be referred to as an optical tap.
2) Coupling a portion of the second electrical data signals 26 to an electrical analyser to determine the electrical signal quality (for example excess electrical noise, poor signal to noise ratio, etc.). This may be referred to as an electrical tap.
3) Coupling a portion of input light from the wavelength demultiplexer 18 to an optical detector to determine optical signal quality. This may be referred to as an optical tap.

For the optical taps, the amount of light coupled from the main light signal may be less than 10%, or less than 5%. An optical tap may take the form of an optical coupler such as an optical fibre coupler.

The light or electrical signals detected in any of the taps may be used to determine whether or not to initiate the use of the tuneable laser 34 and/or wavelength tuneable optical receiver. This may be by comparing the detected tapped signals to thresholds or other criterion or rules. For example, if the light intensity from an optical tap is below a threshold, then this indicates that the remaining light intensity is not of sufficient magnitude to give a good signal if transmitted through the PON. This, for example, may be because the optical transmitter 10a has a fault. In such a circumstance the electronic controller may send a copy of the electrical signals 8a to the tuneable laser, together with a data signal configured to tune the laser to the operating wavelength of the faulty transmitter 10a.

In another example, using a tuneable optical receiver 46, the reduced light intensity identified using an optical tap may be because an optical receiver, 24 has a fault. The electronic controller 4 may consequently send a data signal configured to tune a wavelength filter of the tuneable receiver to the operating wavelength of the faulty receiver 24a.

In a further example, the detection from the optical tap is used to determine a status signal. The status signal may indicate that the light signals output from the respective optical transmitter 10 do not correspond to its respective received electrical data signals. Alternatively, the status signal may indicate that the output electrical data signals output from the respective optical receiver do not correspond to its respective received light signals.

Status information derived from one or more signals, which may indicate whether the electrical signal 36 should be diverted to a wavelength tuneable optical transmitter 34 or the light signal 42 should be diverted to a wavelength tuneable optical receiver, may be determined by comparing the electrical or optical data signals to a threshold.

For example, with regard to the wavelength tuneable optical transmitter, the electronic controller 4 may receive the status information and consequently divert the electrical signal 36 to a tuneable optical transmitter 34 instead of its originally designated optical transmitter 10a if the output light pulses 12 have a greater number of errors (i.e. a greater bit error rate) than a bit error rate threshold. In another example, the electrical signals 36 may be diverted to a tuneable optical transmitter 34 instead of its originally designated optical transmitter 10a if the optical transmitter 10 outputs light at any intensity below an intensity threshold or not at all. Other examples of possible threshold comparisons that may determine the status information include, but are not limited to, intensity rate and pulse duration. Any of these thresholds may be predetermined thresholds.

The wavelength of the light corresponding to a broken transmitter 10 may also be determined using any method and/or apparatus including, but not limited to, inputting a tapped portion of the light into an optical spectrum analyser. Another method would be to have an optical tap and corresponding optical detector for each transmitter.

With regard to the wavelength tuneable optical receiver, the electronic controller 4 may, for example, receive the status information and consequently deliver the light signal 42 to a tuneable optical receiver 46 instead of its originally designated optical transmitter 24a if the output electrical data signals 26 have a greater number of errors (i.e. a greater bit error rate) than a bit error rate threshold. In another example, the light signals 42 may be diverted to a tuneable optical receiver 46 instead of its originally designated optical receiver 24a if the optical receiver 24 outputs a second electrical data signals 26 at a reduced rate or not at all. Other examples of possible threshold comparisons that may determine the status information include, but are not limited to, intensity rate and pulse duration. Any of these thresholds may be predetermined thresholds.

The tuneable optical transmitter apparatus 34 may comprise similar components as described under the subheading ‘optical transmitters’. This apparatus 34 is additionally configured to be tuneable to any wavelength. The tuneable optical transmitter apparatus 34 may for example include, but is not limited to, one or more wavelength tuneable lasers, Light Emitting Diodes (LEDs), other optical sources, optical amplifiers including semiconductor optical amplifiers and/or optical tuneable filters. The wavelength tuneable laser, LEDs or other optical source may emit light signals at any wavelength or at a specific wavelength, the optical amplifier may amplify the light signal and the optical tuneable filter may allow a specific wavelength to be selected. The wavelength tuneable laser system may, for example, comprise a tuneable laser directly modulated using electrical signals from the electronic controller or a tuneable laser configured to output continuous wave of light. Examples of tuneable lasers may include, but are not limited to, solid-state lasers, bulk tuneable lasers, dye lasers and free electron lasers.

One or more of the optical transmitters 10 may be tuneable. A plurality of wavelength tuneable optical transmitters may be incorporated into the apparatus 2.

The tuneable optical receiver apparatus 46 may comprise similar components as described under the subheading ‘optical receivers’. This apparatus 46 is additionally configured to be tuneable to any wavelength. The optical receiver apparatus 46 may comprise one or more photodetectors that convert light signals into electrical signals. The tuneable optical receiver 46 may form part of a transceiver.

One or more of the optical receivers 24 may be tuneable. A plurality of wavelength tuneable optical receivers may be incorporated into the apparatus 2.

Any component of the apparatus 2, such as the electronic controller 4, may be configured to receive the status signal and/or status information associated with the light output from at least one of the optical transmitters 10. This may identify an optical transmitter 10 which is faulty and hence which wavelength the tuneable optical transmitter 34 should be tuned to, to accommodate the associated signals of the faulty optical transmitter 10. The electrical signal 36 may then be outputted to the wavelength tuneable optical transmitter apparatus 34 based on the status signal. The tuneable optical transmitter 34 may convert the electrical signals into light signals, as described under the sub-heading, ‘optical transmitter’.

The light signals 35 from the wavelength tuneable optical transmitter 34 may be transmitted to an optical coupler 35, a wavelength multiplexer 14 or any other component that can introduce the optical signals output from the tuneable laser into the PON.

Any component of the apparatus 2, such as the electronic controller 4, may be configured to receive the status signal and/or status information associated with the second electrical data signals output from at least one of the optical receivers 24. This may identify an optical receiver 24 which is faulty and hence which wavelength the tuneable optical receiver 46 should be tuned to, to accommodate the associated signals of the faulty optical receiver 24. The light signal 42 may then be outputted to the wavelength tuneable optical receiver apparatus 4 based on the status signal. The tuneable optical receiver 46 may convert the light signals into data signals, for example using one or more photodetectors.

The wavelength tuneable optical transmitter and wavelength tuneable optical receiver may form the same device. For example, the apparatus 2 may comprise a wavelength tuneable optical transceiver.

### Optical Coupler

The apparatus 2 may comprise one or more optical couplers 38. The optical coupler 38 may be configured to couple the light signals 35 from the wavelength tuneable optical transmitter 34 into the wavelength multiplexed optical output signal 16 or into an input of the mux 14. This may be to ensure both signals from the optical transmitters 10 (which may have since passed through other components such as a wavelength multiplexer) and signals from the wavelength tuneable optical transmitter are transmitted to the further mux/demux 30 via a single optical fibre. This coupling may, for example, be situated between the output port of the wavelength multiplexer 14 and the optical unit 28 or between the optical unit 28 and a further mux/demux 30. A similar optical coupler 38 may be used to couple out a portion of light from path 20 into path 42 in FIG. 5 (not shown in this figure).

### Transceiver

The apparatus 2 described herein may additionally comprise a device or plurality of devices configured to receive optical signals from other connecting networks, for example long haul networks. The transceiver(s)/other device(s) may comprise one or more photodetectors to convert optical signals into electrical signals.

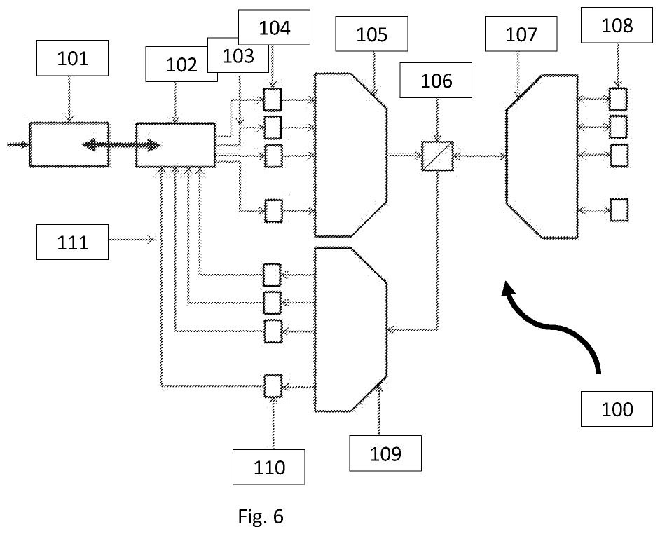

An example configuration of the apparatus 100 described herein, including a transceiver 101, is displayed in FIG. 6.

The electronic controller 4 in the apparatus 2 described herein may be configured to receive input electrical data signals 6 from the transceiver 101. The electronic controller 4 may also be configured to transmit electrical data signals, to the transceiver 101/another device. The data signals transmitted to the transceiver may be those transmitted upstream from the end user terminals 32.

The said transceiver 101 may, for example, be a high data capacity optical transceiver. Examples of compatible transceivers may include, but are not limited to, extended range optical transceivers, 10 gigabit small form-factor pluggable (XFP), and C form-factor pluggable transceivers.

Possible types of receivers that may be used to receive the optical signals from other connecting networks include, but are not limited to p-i-n receivers and avalanche photodiode (APD) receivers. Possible types of transmitters that may be used to transmit the optical signals from other connecting networks include, but are not limited to LED transmitters, laser diode transmitters and/or any other optical source transmitter, for example.

FIG. 6 shows a schematic view of an example of the apparatus 2, 100 as described herein. The apparatus 100 in this example may be modified according to any feature or configuration described herein. The apparatus 100 in this example shows a reconfigurable WDM-PON architecture. The transceiver that feeds to the electronic controller 102 in this example is a high data capacity optical transceiver 101, such as a Quadrature Small Form-factor Pluggable (QSFP). In this example, data arrives at the optical transceiver 101 at 100 GB/s over a LC duplex fibre connection. The transceiver may convert the optical signals into a single 100 GB/s electrical data channel that feeds into the electronic controller 102. In another example, data may arrive at the optical transceiver 101 at 400 GB/s and be converted into a 400 GB/s electrical data channel that also feeds into the electronic controller 102. This electrical controller 102 may be configured to generate multiple data streams with different data rates and electrically switch these streams to different output ports 103, which in turn may feed the optical transmitters 104.

The output electrical ports 103 may be connected to an array of different wavelength specific transmitters 104 such that each transmitter wavelength may be combined by an AWG 105 and transmitted over optical fibre to a downstream AWG 107. The corresponding wavelengths of 104 may be routed to different spatial output ports of 107 such that each node may receive a specific wavelength. By electrically routing the required electrical data and data rate at 102, this stream then may be received by a specific output node attached to 107. The node transceivers 108 may receive the data, and transmit data upstream in a different waveband. A waveband splitter or optical circulator 106 may direct the upstream data to an AWG 109 that demultiplexes the node data to an array of optical receivers 110. Electrical data from the array of optical receivers 110 may be input to the electrical mux/switch 102 where an aggregate high capacity data stream may be generated to drive the optical output of the optical transceiver 101. The data rates for each stream can be different in the downstream and upstream direction as required. The electrical mux/demux/switch 102 may also contain a network controller to reconfigure the data rate to each user, both in downstream and upstream directions. The array of wavelength specific transmitters 104, the array of optical receivers 110 and the node transceivers 108 can contain reconfigurable electrical drivers and transimpedance amplifiers that can be changed and optimised for the specific data rate that is being transmitted to each network node for a given configuration. In this manner, the aggregate data capacity of 101 can be divided for each user and reconfigured, potentially controlled by the network controller in 102.

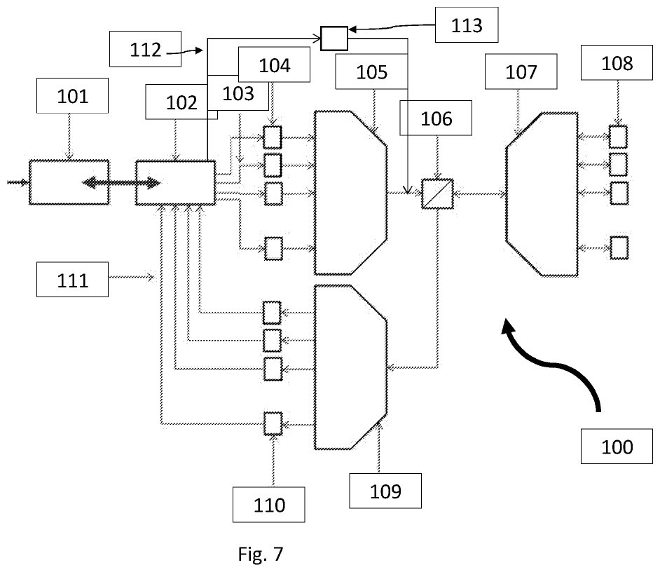

FIG. 7 shows an example, similar to FIG. 6 where a tuneable laser 113 is used to transmit light signals 112 when one of the optical transmitters 104 is faulty.

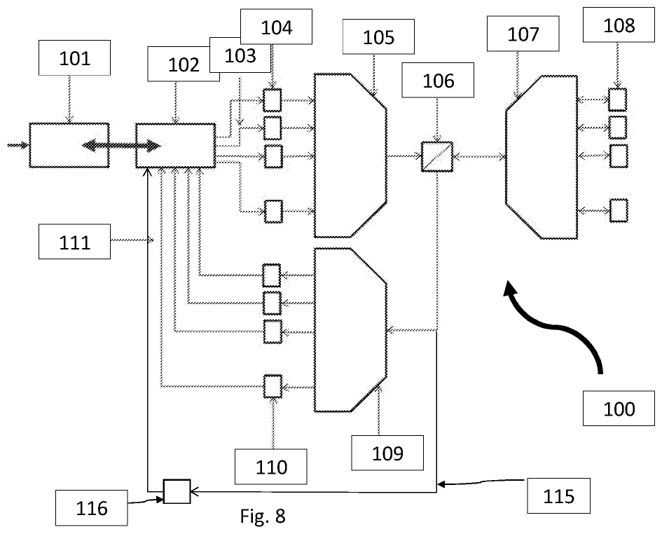

FIG. 8 shows an example, similar to FIG. 6 where a wavelength tuneable optical receiver 116 is used to receive light signals 115 when one of the optical receivers 110 is faulty.

The examples shown in FIGS. 6, 7 and 8 may be adapted using any of the optional components and configuration discussed herein.

1. An apparatus for use with a Wavelength Division Multiplexed Passive Optical Network, WDM-PON;
the apparatus comprising:
I) an electronic controller configured to:
a. receive first input electrical data signals; and,
b. output a plurality of electrical data signals based upon the input electrical data signals; the output electrical data signals being output on a plurality of data channels;
c. change the data rate of at least a first of the plurality of output electrical data signals;
II) a plurality of optical transmitters for receiving the plurality of electrical data signals; wherein each said optical transmitter is configured to:
d. receive, respectively on different data channels, electrical data signals output from the electronic controller; and,
e. output light signals corresponding to the received electrical data signals from the electronic controller;
f. output its respective light signals centered on a different wavelength to the light signals of the other optical transmitters;
III) a wavelength multiplexer configured to receive the output light signals from the optical transmitters and output a wavelength multiplexed optical output signal.

2. (canceled)

3. An apparatus as claimed in claim 1 further comprising:
I) a wavelength demultiplexer configured to receive wavelength multiplexed input light and output a plurality of light signals on different output paths; the output light signals being centered on different wavelengths;
II) a plurality of optical receivers for:
receiving the plurality of output light signals from the wavelength demultiplexer; and,
outputting corresponding second electrical data signals to the electronic controller.

4-5. (canceled)

6. An apparatus as claimed in claim 1 wherein the electronic controller is configured to change the data rate of any of its plurality of output electrical data signals.

7. An apparatus as claimed in claim 1 wherein the electronic controller is configured to change the data rate of at least the first electrical data signal based on any of:
A) An analysis of the input electrical data signals received by the electronic controller
B) A data signal received by the electronic controller that is configured to cause the electronic controller to change a data rate.

8. An apparatus as claimed in claim 3, wherein the electronic controller is configured to change the said data rate based on one or more of the electrical data signals output from one or more of the plurality of optical receivers.

9. An apparatus as claimed in claim 1 further comprising a wavelength tuneable optical transmitter apparatus configured to:
receive an electrical data signal associated with the said plurality of data signals; and,
output corresponding light signals.

10. An apparatus as claimed in claim 9 comprising an optical coupler configured to couple the light signals output from the wavelength tuneable optical transmitter into the wavelength multiplexed optical output signal.

11. An apparatus as claimed in claim 9 configured to:
receive a status signal comprising data associated with the light output from at least one of the optical transmitters of the plurality of optical transmitters;
output the electrical signal to the wavelength tuneable optical transmitter apparatus based upon the status signal.

12. An apparatus as claimed in 11 wherein the status signal indicates that the light signals output from the respective optical transmitter do not correspond to its respective received electrical data signals.

13. An apparatus as claimed in claim 9 wherein the electrical signals transmitted to the wavelength tuneable optical transmitter apparatus comprise:
A) one or more signals for determining the center output wavelength of the wavelength tuneable optical transmitter; and,
B) the electrical data signals output to the said at least one optical transmitter associated with the status signal.

14. An apparatus as claimed in claim 9 wherein the wavelength tuneable optical transmitter apparatus comprises a wavelength tuneable laser.

15. An apparatus as claimed in claim 3, wherein the electronic controller is further configured to:
receive the first input electrical data signals from a transceiver;
output electrical data signals, based on the second electrical data signals, to the said transceiver.

16-20. (canceled)

21. An apparatus for use with a Wavelength Division Multiplexed Passive Optical Network, WDM-PON;
the apparatus comprising:
I) an electronic controller configured to:
a. receive first input electrical data signals; and,
b. output a plurality of electrical data signals based upon the input electrical data signals; the output electrical data signals being output on a plurality of data channels;
II) a plurality of optical transmitters for receiving the plurality of electrical data signals; wherein each said optical transmitter is configured to:
c. receive, respectively on different data channels, electrical data signals output from the electronic controller; and,
d. output light signals corresponding to the received electrical data signals from the electronic controller;
e. output its respective light signals centered on a different wavelength to the light signals of the other optical transmitters;
III) a wavelength multiplexer configured to receive the output light signals from the optical transmitters and output a wavelength multiplexed optical output signal;
IV) a wavelength tuneable optical transmitter configured to:
f. receive one or more of the plurality of electrical data signals output from the electronic controller; and,
g. output light signals corresponding to the received electrical data signals from the electronic controller.

22. An apparatus as claimed in claim 21 wherein the wavelength of the light signal output from the wavelength tuneable optical transmitter is substantially the same as the wavelength of at least one of the said plurality of optical transmitters.

23. An apparatus as claimed in claim 21 wherein the apparatus is configured to initiate the output of light from the wavelength tuneable optical transmitter upon the detection of a fault associated with the operation of the apparatus.

24. An apparatus as claimed in claim 23 wherein the fault is associated with one or more of the plurality of optical transmitters.

25. An apparatus as claimed in claim 24 wherein, upon detection of the fault, the apparatus is configured to transmit one or more signals to the wavelength tuneable optical transmitter to, in any order:
A) output light;
B) tune its output wavelength to the wavelength of the faulty optical transmitter.

26. An apparatus as claimed in claim 24 wherein the electronic controller is configured to output electrical data signals to the wavelength tuneable optical transmitter upon detection of the fault; the electrical data signals output to the wavelength tuneable optical transmitter based upon the said input electrical data signals.

27. (canceled)

28. An apparatus as claimed in claim 21 comprising an optical coupler configured to:
receive wavelength multiplexed optical output signal from the wavelength multiplexer;
receive light output from the wavelength tuneable optical transmitter;
output light, along a common optical path, from the wavelength tuneable optical transmitter and wavelength multiplexer.

29. (canceled)

30. An apparatus for use with a Wavelength Division Multiplexed Passive Optical Network, WDM-PON;
the apparatus comprising:
I) an electronic controller configured to:
a. receive first input electrical data signals; and,
b. output a plurality of electrical data signals based upon the input electrical data signals; the output electrical data signals being output on a plurality of data channels;
II) a plurality of optical transmitters for receiving the plurality of electrical data signals; wherein each said optical transmitter is configured to:
c. receive, respectively on different data channels, electrical data signals output from the electronic controller; and,
d. output light signals corresponding to the received electrical data signals from the electronic controller;
e. output its respective light signals centered on a different wavelength to the light signals of the other optical transmitters;
III) a wavelength multiplexer configured to receive the output light signals from the optical transmitters and output a wavelength multiplexed optical output signal;
IV) a wavelength demultiplexer configured to receive wavelength multiplexed input light and output a plurality of light signals on different output paths; the output light signals being centered on different wavelengths;
VI) a plurality of optical receivers for:
receiving the plurality of output light signals from the wavelength demultiplexer; and,
outputting corresponding second electrical data signals to the electronic controller;
VII) a wavelength tuneable optical receiver configured to:
f. receive wavelength multiplexed input light and,
g. select a wavelength to detect from the said input light;
h. output an electrical data signal to the electronic controller, based on the detected wavelength.
